(19) United States
(12) Patent Application Publication
(10) Pub. No.: US 2021/0343172 A1
(43) Pub. Date: Nov. 4, 2021

(54) INFORMATION PROCESSING DEVICE, INFORMATION PROCESSING METHOD, AND PROGRAM

(71) Applicant: SONY CORPORATION, TOKYO (JP)

(72) Inventors: KAZUHIRO WATANABE, TOKYO (JP); YOSHIHIKO IKENAGA, TOKYO (JP); MARIKA NOZUE, TOKYO (JP)

(21) Appl. No.: 17/250,599

(22) PCT Filed: Jul. 2, 2019
(86) PCT No.: PCT/JP2019/026356

§ 371 Date: Feb. 8, 2021

(30) Foreign Application Priority Data
Aug. 16, 2018 (JP) 2018-153228

(51) Int. Cl. G09B 5/02; G06F 3/0484; G06F 3/0488

(52) U.S. Cl. CPC G09B 5/02; G09B 5/06; G06F 3/0488; G06F 3/04842

(57) ABSTRACT

Provided is an information processing device, an information processing method, and a program which enable more appropriate character string notation change control to be performed with respect to a user. An information processing device (1) includes a control unit (100), the control unit being configured to perform: control to display a character string using a predetermined notation mode corresponding to the school grade of a user; and control to change to a notation mode in which related information is co-displayed together with a character selected by the user and a character belonging to the same proficiency level group as the selected character, out of the character string.

### TECHNICAL FIELD

The present disclosure relates to an information processing device, an information processing method, and a program.

### BACKGROUND ART

As a result of developments in communication technology in recent years, there have been proposed techniques for providing classes to users and for posing questions and eliciting answers online via a network such as the internet.

In relation to techniques for displaying character strings on a display device, PTL 1 mentioned hereinafter, for example, discloses a feature whereby the kana reading of a kanji character string contained in the body of an email is displayed when the kanji character string is selected using a sliding touch operation.

### CITATION LIST

### Patent Literature

### [PTL 1]

JP 2010-128539 A

### SUMMARY

### Technical Problem

Here, there is known a notation method (so-called ruby display) for co-displaying related information such as the kana reading of a kanji character, in such a way as to be smaller than the kanji characters in the body. In relation to learning content, it is desirable to employ ruby display specific to the school grade, but the necessity for ruby display differs depending on the language proficiency level of each learner (user), and it is not necessarily appropriate for ruby display to be switched in accordance with age.

Further, in PTL 1 discussed hereinabove, an operation must be performed for each character that cannot be read, imposing a heavy operational burden.

Accordingly, the present disclosure proposes an information processing device, an information processing method, and a program which enable more appropriate character string notation change control to be performed with respect to a user.

### Solution to Problem

The present disclosure proposes an information processing device including a control unit, the control unit being configured to perform: control to display a character string using a prescribed notation mode corresponding to the school grade of a user; and control to switch the notation mode to another such that related information is co-displayed together with a character selected by the user and a character belonging to the same proficiency level group as the selected character, out of the character string.

The present disclosure proposes an information processing method including the steps executed by a processor of: performing control to display a character string using a predetermined notation mode corresponding to the school grade of a user; and performing switch the notation mode to another such that related information is co-displayed together with a character selected by the user and a character belonging to the same proficiency level group as the selected character, out of the character string.

The present disclosure proposes a program for causing a computer to function as a control unit configured to perform: control to display a character string using a predetermined notation mode corresponding to a school grade of a user; and control to switch the notation mode to another such that related information is co-displayed together with a character selected by the user and a character belonging to the same proficiency level group as the selected character, out of the character string.

### Advantageous Effects of Invention

The present disclosure as described hereinabove enables more appropriate character string notation change control to be performed with respect to a user.

It should be noted that the advantages described hereinabove are not necessarily restrictive, and any of the advantages indicated in this specification, or other advantages that can be understood from this specification, may be exhibited in conjunction with the advantages described hereinabove or instead of the advantages described hereinabove.

### BRIEF DESCRIPTION OF DRAWINGS

FIG. 1 is a diagram used to describe in summary a learning support system according to an embodiment of the present disclosure.

FIG. 2 is a block diagram illustrating an example of the configuration of an information processing terminal according to the present embodiment.

FIG. 3 is a diagram used to describe an example, according to the present embodiment, in which a swipe operation is used to switch to a notation with co-displayed furigana.

FIG. 4 is a diagram used to describe an example, according to the present embodiment, in which a swipe operation is used to switch to a notation with the furigana hidden.

FIG. 5 is a diagram used to describe an example, according to the present embodiment, in which word information is displayed.

FIG. 6 is a diagram used to describe an example, according to the present embodiment, in which phonetic symbols are displayed.

FIG. 7 is a diagram used to describe an example, according to the present embodiment, in which a swipe operation is used to convert the character type.

FIG. 8 is a block diagram illustrating an example of the configuration of a management server according to the present embodiment.

FIG. 9 is a flowchart illustrating an example of the overall flow of notation switching control processing in a learning support system according to the present embodiment.

### DESCRIPTION OF EMBODIMENTS

A preferred embodiment of the present disclosure will now be described in detail with reference to the accompanying drawings. It should be noted that in the description and the figures, duplicate descriptions are omitted by using the same reference signs to denote constituent elements having substantially the same functional configuration.

Further, the description is given in the following order.

1. Outline of learning support system according to an embodiment of the present disclosure

2. Configuration examples

2-1. Configuration example of information processing terminal 1

2-2. Configuration example of management server 2

3. Operation processing

4. Summary

### 1. OUTLINE OF LEARNING SUPPORT SYSTEM ACCORDING TO AN EMBODIMENT OF THE PRESENT DISCLOSURE

A learning support system according to an embodiment of the present disclosure enables more appropriate character string notation change control to be performed with respect to a user when a computer is being used to present learning content to a learner. The learning content may include data used for learning, such as question sentence data, explanation sentence data, textbook data, and reference book data. Further, the content is not limited to learning content, and may be content such as an electronic book.

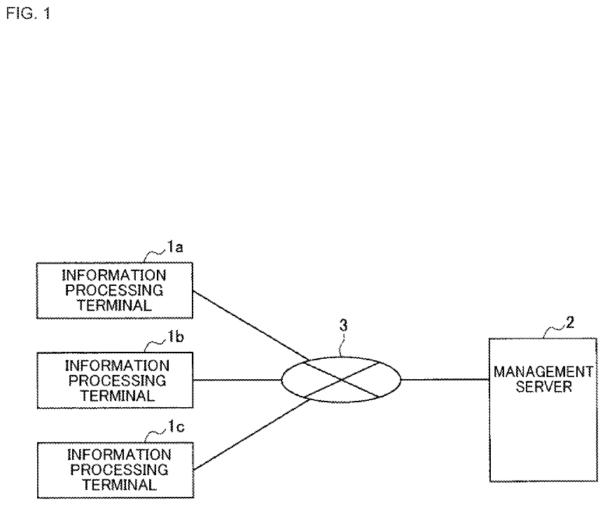

FIG. 1 is a diagram used to describe the overall configuration of the learning support system according to the embodiment of the present disclosure. As illustrated in FIG. 1, the learning support system according to the present embodiment includes an information processing terminal 1 and a management server 2 which are connected via a network 3.

The information processing terminal 1 is realized by means of a PC (personal computer), a tablet terminal, a smartphone, a mobile telephone terminal, or a transparent-type/non-transparent-type HMD (Head Mounted Display), for example. The information processing terminal 1 displays, on a display unit, question data received from the management server 2, and transmits, to the management server 2, answer data input by the learner.

The management server 2 includes a database that stores the learning content. Further, the management server 2 is capable of analyzing ruby display switching information obtained from the learner, and calculating a learning proficiency level (in particular, a language proficiency level) of the learner.

The learning support system according to the embodiment of the present disclosure has now been described. The specific configurations of each device included in the learning support system according to the present embodiment will next be described.

### 2. CONFIGURATION EXAMPLES

<2-1. Configuration Example of Information Processing Terminal 1>

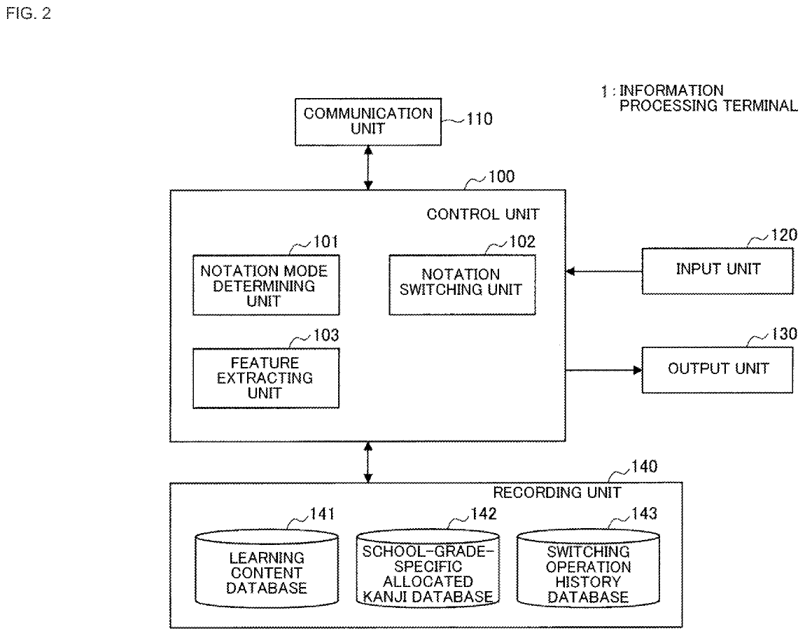

FIG. 2 is a block diagram illustrating an example of the configuration of the information processing terminal 1 according to the present embodiment. As illustrated in FIG. 2, the information processing terminal 1 includes a control unit 100, a communication unit 110, an input unit 120, an output unit 130, and a storage unit 140.

The control unit 100 functions as an arithmetic processing device and a control device, and controls the overall operation within the information processing terminal 1 in accordance with various programs. The control unit 100 is realized by means of an electronic circuit such as a CPU (Central Processing Unit) or a microprocessor. Further, the control unit 100 may include a ROM (Read Only Memory) for storing programs and computation parameters that are to be used, and a RAM (Random Access Memory) for temporarily storing parameters and the like that vary as appropriate.

Further, the control unit 100 according to the present embodiment also functions as a notation mode determining unit 101, a notation switching unit 102, and a feature extracting unit 103.

The notation mode determining unit 101 determines the notation mode for the learning content on the basis of user information. For example, the notation mode determining unit 101 determines the predetermined notation mode corresponding to the school grade of a user on the basis of the age of the user or school grade information. The predetermined notation mode corresponding to the school grade relates, for example, to the character type being used (such as kanji, hiragana, katakana, alphabet), and whether related information such as furigana, phonetic symbols, or meanings (for example, ruby display/non-display of furigana) is to be co-displayed. Besides furigana relating to kanji, furigana may also be hiragana furigana relating to katakana, or furigana relating to symbols, units, or abbreviations, for example (such as “gram” for “g”, or “database” for “DB”).

At this time, the notation mode determining unit 101 determines which character type to use to display which character, and the characters for which the related information is to be co-displayed, for example, on the basis of “curriculum guideline information” for prescribing the content to be learned in each school grade, and “Gakunen-betsu Haito Kanji Toho (School-grade-specific allocated kanji information)” for allocating the kanji to be learned in each school grade. For example, the notation mode determining unit 101 determines kanji notation for kanji that are learned up to the school grade of a user, and either hiragana notation or kanji notation with co-displayed furigana for kanji that are not learned in the school grade of a user.

The supported character type is not limited to “kanji”, and in the case of foreign language learning content, the notation mode determining unit 101 may, for example, designate a mode in which the meaning is co-displayed in the native language for words that are not learned up to a school grade of a user. Further, the notation mode determining unit 101 may designate a mode in which phonetic symbols are co-displayed with words that are not learned up to the school grade of the user.

It should be noted that the age or school grade information of a user is first regarded as the proficiency level of the user to determine the notation mode, but if the age or school grade information of the user cannot be acquired from the management server 2, for example, the control unit 100 may invite a user to input information on the age or school grade of the user. Further, in the case of users who are learning sentences that are not in their native language, or users for which it is difficult to determine the (language) proficiency level merely from their age, such as in the case of children who have returned from abroad, the control unit 100 may on the first occasion carry out a simple literacy classification test or the like to acquire an (assumed) age or school grade information corresponding to the proficiency level of the user.

The notation switching unit 102 performs control such that, if a predetermined user operation to select a character is performed with respect to a character string being displayed in a notation mode that has been determined by the notation mode determining unit 101, the notation of the character and characters belonging to the same proficiency level group as the character, out of the character string, is switched. The predetermined user operation for selecting the character may, for example, be a touch operation, or more specifically a swipe operation in which the target character is traced using a finger. The selection operation is not limited to a touch operation, and may be an operation employing a mouse or a keyboard, speech input, or line-of-sight input.

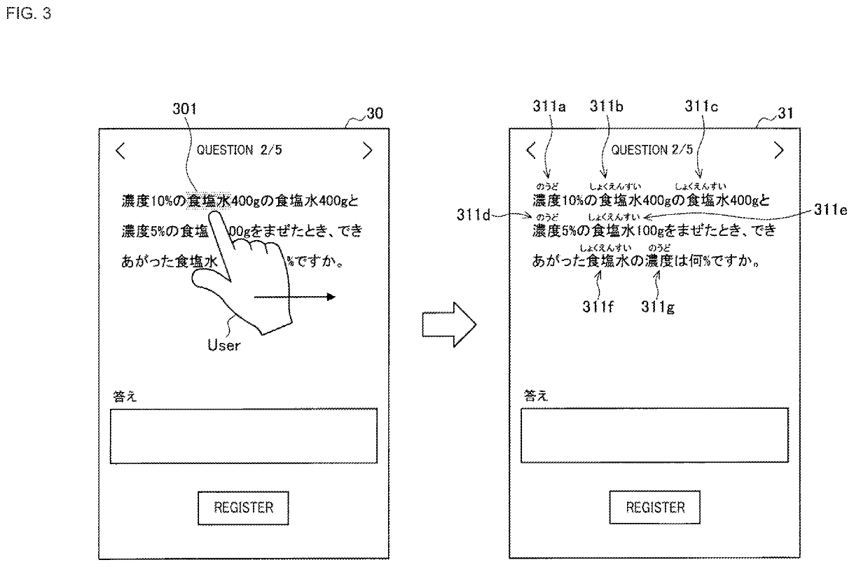

The “proficiency level group” described hereinabove is, for example, one or a plurality of groups specific to each character proficiency level, based on the “Gakunen-betsu Haito Kanji Toho (School-grade-specific allocated kanji information)” discussed hereinabove, for example (an example of character learning content specific to the school grade). For example, the notation switching unit 102 performs control to switch the characters 301 that have been selected using a swipe operation (the kanji characters “ [symbol] ” [saline solution] in the example illustrated in FIG. 3), as illustrated on the screen 30 on the left of FIG. 3, and all other characters that are learned in the school grade in which the character is learned (the kanji characters “ [symbol] ” [concentration] in the example illustrated in FIG. 3), to displays 311a to 311g, in which furigana is co-displayed using hiragana, together with the kanji, as illustrated on the screen 31 on the right of FIG. 3.

In this way, if, for example, a user is in the fourth grade at school, but cannot read fourth-grade level kanji (kanji that are learned in the fourth grade), then by swiping at least one fourth-grade level kanji, all fourth-grade level kanji in the character string can be switched to a display in which hiragana furigana are co-displayed, without performing an operation each time. It should be noted that if the fourth-grade level kanji are divided into a plurality of groups in accordance with the level of difficulty, for example, then simultaneous switching of the furigana co-display may be controlled in units of groups, without being limited to switching all the fourth-grade level kanji. As a result, the notation mode is controlled to match the learning level of a user, without the user performing an operation each time, thereby enhancing the convenience of the learning content.

Further, the notation switching unit 102 may similarly implement furigana co-display for buttons or display titles, for example, in addition to character strings.

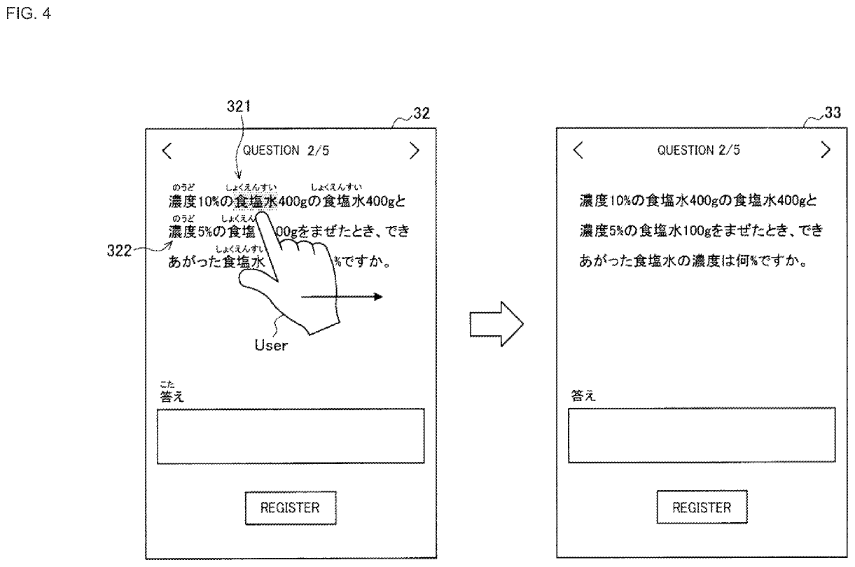

Further, the notation switching unit 102 can also perform display control to hide the related information, such as furigana, if a predetermined user operation is performed with respect to characters that are notated with co-display of the related information. For example, the notation switching unit 102 performs control to switch the characters 321 that have been selected using a swipe operation (the kanji characters “ [symbol] *” with hiragana“ [symbol] ” co-displayed in a small character size in the example illustrated in FIG. 4), as illustrated on the screen 32 on the left of FIG. 4, and all other characters that are learned in the school grade in which the characters are learned (the kanji characters “ [symbol] ” with hiragana “ [symbol] ” co-displayed in a small character size (characters 322, for example) in the example illustrated in FIG. 4), to be displayed without the furigana, as illustrated on the screen 33 on the right of FIG. 4.

It should be noted that the notation switching unit 102 may, after switching to notation with co-display of furigana or the like, return to a display without co-display if the co-display notation is displayed a certain number of times.

Further, besides collectively converting to a notation with co-display of furigana, the notation switching unit 102 may display the meaning or the pronunciation of the characters selected by a user.

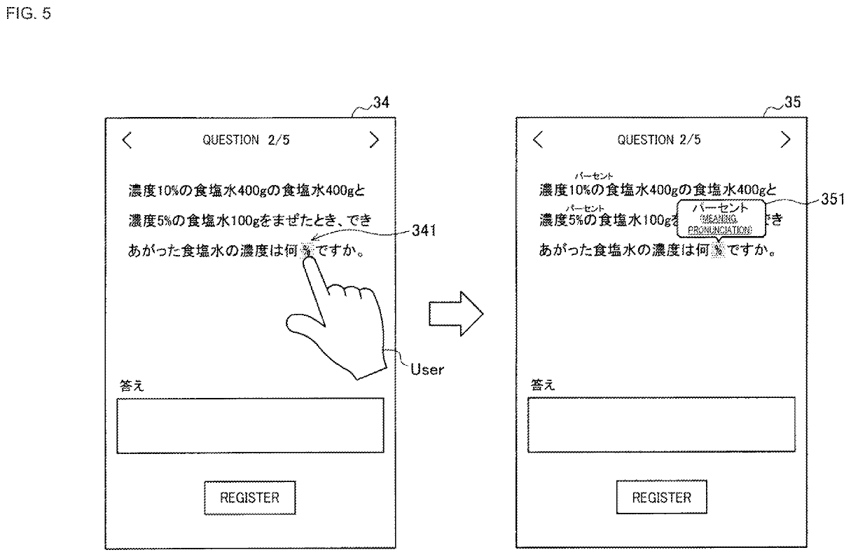

FIG. 5 is a diagram used to describe an example, according to the present embodiment, in which word information is displayed. If a user presses and holds a symbol 341 (the “%” symbol in the example illustrated in FIG. 5) in the displayed character string, for example, as illustrated on the screen 34 on the left of FIG. 5, the notation switching unit 102 may display furigana for all the “%” symbols contained in the character string, as illustrated on the screen 35 on the right of FIG. 5, and may also display word information 351 indicating meaning or pronunciation information of the selected character. The control unit 100 displays the meaning information of the character if “meaning” in the word information 351 is tapped, for example, and displays the pronunciation information of the character, or performs speech output of a pronunciation voice, if “pronunciation” is tapped. Performing speech output of a pronunciation voice enables the pronunciation of the word to be learned (besides being used to study pronunciations in a foreign language, this can also be used to correct dialects, for example).

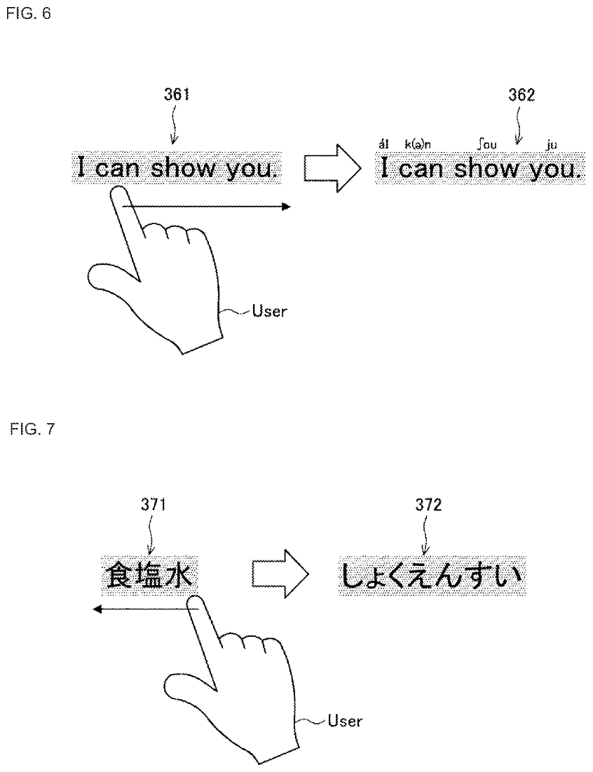

FIG. 6 is a diagram used to describe an example, according to the present embodiment, in which phonetic symbols are displayed. If, for example, a character string 361 is swiped (“I can show you” in the example illustrated in FIG. 6), as illustrated in FIG. 6, the notation switching unit 102 switches to a notation display 362 in which phonetic symbols relating to the selected characters are co-displayed in a small size as the related information. At this time, the notation switching unit 102 may also switch to a notation having co-display of phonetic symbols for character strings including other words belonging to the same proficiency level group as the words in the character string 361 selected by the swipe operation.

Further, in the case of foreign language learning content, for example, the notation switching unit 102 may convert to a display in which the meaning of the words selected by the user operation is co-displayed using the native language of a user. In this case also, the notation switching unit 102 may convert to a display in which the meanings relating to words belonging to the same proficiency level group (for example, a group based on “school-grade-specific allocated English word information” or the like) as the selected words are additionally co-displayed using the native language of a user.

Further, the notation switching unit 102 may perform control to convert the character type in accordance with a user operation. FIG. 7 is a diagram used to describe an example, according to the present embodiment, in which a swipe operation is used to convert the character type. If, as illustrated on the left in FIG. 7, a kanji character string 371 is swiped in the opposite direction to the swipe operation illustrated on the left of FIG. 3, for example, the selected character string is converted into a hiragana character string 372, as illustrated on the right in FIG. 7. In this case also, the notation switching unit 102 may convert to a display of the hiragana relating additionally to words belonging to the same proficiency level group (for example, a group based on the “Gakunen-betsu Haito Kanji Toho (School-grade-specific allocated kanji information)” or the like) as the selected word.

Further, in the case of foreign language learning content, for example, the notation switching unit 102 may perform control to convert the selected foreign language words to native language words in response to a predetermined user operation (for example, a swipe operation in the opposite direction to the swipe operation prescribing co-display of the meaning or phonetic symbols). In this case also, the notation switching unit 102 may additionally convert to a native language display for words belonging to the same proficiency level group as the selected words.

The feature extracting unit 103 extracts feature data relating to the character proficiency of a user, on the basis of the history of notation switch operations performed by the user. More specifically, the feature extracting unit 103 classifies the character information selected by a user, and converts the same to data, as awkward characters. Further, the extracted feature data are transmitted to the management server 2. Further, the feature extracting unit 103 can also calculate the character proficiency level (language proficiency level) of a user on the basis of the feature data. The notation mode determining unit 101 may determine a notation mode suited to the user in accordance with the calculated language proficiency level.

(Communication Unit 110)

The communication unit 110 is connected by wire or wirelessly to an external device, and transmits and receives data. The communication unit 110 is connected to a network 3 by means of a wired/wireless LAN (Local Area Network), or Wi-Fi (registered trademark), Bluetooth (registered trademark), or a mobile communication network (LTE (Long Term Evolution), 3G (third generation mobile communication system)), for example, and transmits and receives data to and from the management server 2 via the network 3.

(Input Unit 120)

The input unit 120 acquires information input into the information processing terminal 1, and outputs the same to the control unit 100. The input unit 120 is realized, for example, by means of an operation input unit or a speech input unit (microphone). The operation input unit accepts operation instructions from a user, and outputs the operation content thereof to the control unit 100. The operation input unit may be a touch sensor, a pressure sensor, or a proximity sensor. Alternatively, the operation input unit may have a physical configuration such as a button, a switch, or a lever.

(Output Unit 130)

The output unit 130 is realized by means of a display unit for displaying various screens, or a speech output unit (speaker) for outputting speech information.

(Storage Unit 140) The storage unit 140 is realized by means of a ROM (Read Only Memory) for storing programs and computation parameters used for processing by the control unit 100, and a RAM (Random Access Memory) for temporarily storing parameters and the like that vary as appropriate.

Further, the storage unit 140 may also store a learning content database 141, a school-grade-specific allocated kanji database 142, and a switching operation history database 143.

The configuration of the information processing terminal 1 according to the present embodiment has been specifically described hereinabove. It should be noted that the configuration of the information processing terminal 1 is not limited to the example illustrated in FIG. 2. For example, the information processing terminal 1 may be configured from a plurality of devices, and the databases stored in the storage unit 140 may be provided in an external device, and data transmitted and received as required via the communication unit 110.

<2-2. Configuration Example of Management Server 2>

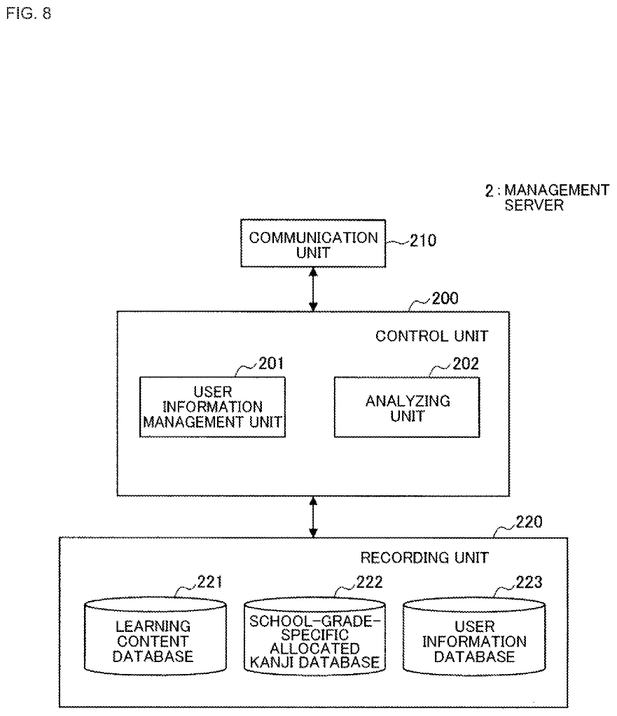

FIG. 8 is a block diagram illustrating an example of the configuration of the management server 2 according to the present embodiment. As illustrated in FIG. 3, the management server 2 includes a control unit 200, a communication unit 210, and a storage unit 220.

(Control Unit 200)

The control unit 200 functions as an arithmetic processing device and a control device, and controls the overall operation within the management server 2 in accordance with various programs. The control unit 200 is realized by means of an electronic circuit such as a CPU (Central Processing Unit) or a microprocessor. Further, the control unit 200 may include a ROM (Read Only Memory) for storing programs and computation parameters that are to be used, and a RAM (Random Access Memory) for temporarily storing parameters and the like that vary as appropriate.

Further, the control unit 200 according to the present embodiment also functions as a user information management unit 201 and an analyzing unit 202.

The user information management unit 201 acquires the name, age and school grade information, preference information, and learning proficiency level (language proficiency level, for example) of a user, and records the same in a user information database 223. Further, the user information management unit 201 records, in the user information database 223, the notation switching operation history of a user, acquired from the information processing terminal 1, and the feature data extracted by the feature extracting unit 103 of the information processing terminal 1.

The analyzing unit 202 analyzes the feature data relating, for example, to the notation switching operation history of a user or to the characters that are awkward for the user, recorded in the user information database 223, and calculates the language proficiency level for a user group (for example, a class or school grade). Further, the analyzing unit 202 is also capable of determining the level of difficulty, for the user group, of various characters, on the basis of the data analysis.

By presenting the calculated language proficiency level to the teacher, for example, the language proficiency level of the class can be more accurately ascertained.

(Communication Unit 210)

The communication unit 210 is connected by wire or wirelessly to an external device, and transmits and receives data. The communication unit 210 is connected to the network 3 by means of a wired/wireless LAN (Local Area Network), or Wi-Fi (registered trademark), Bluetooth (registered trademark), or a mobile communication network (LTE (Long Term Evolution), 3G (third generation mobile communication system)), for example, and transmits and receives data to and from the information processing terminal 1 via the network 3.

(Storage Unit 220)

The storage unit 220 is realized by means of a ROM for storing programs and computation parameters used for processing by the control unit 200, and a RAM for temporarily storing parameters and the like that vary as appropriate.

Further, the storage unit 220 may also store a learning content database 221, a school-grade-specific allocated kanji database 222, and a user information database 223. Learning content data and the Gakunen-betsu Haito Kanji Toho (School-grade-specific allocated kanji information) that are to be stored in the storage unit 220 may be transmitted, as appropriate, to the information processing terminal 1. Further, the user information database 223 accumulates, as information relating to a user (learner), profile information of the user (name, age, school grade, class, and icon image, for example), the learning proficiency level, and the switching operation history, for example. Further, the school-grade-specific allocated kanji database 222 is included in the configuration here, as an example, to control the “co-display notation of furigana for kanji (or meaning, phonetic symbols or the like)”, but the present embodiment is not limited thereto. For example, control of “co-display notation of furigana/phonetic symbols/meaning or the like together with the alphabet (abbreviations, English words)” may similarly be performed, and in this case, predetermined curriculum guideline information corresponding to school grade or age, such as a Gakunen-betsu Eitango Haito Hyo (school-grade-specific English word allocation list), is used. Further, such curriculum guideline information (Gakunen-betsu Kanji Haito Hyo (school-grade-specific kanji allocation list), Gakunen-betsu Eitango Haito Hyo (school-grade-specific English word allocation list) and the like) may be generated and stored in advance, or may be generated automatically, as appropriate, by machine learning or the like on the basis of the learning proficiency level of the student, or on the basis of the history of switching operations according to the present embodiment, for example.

The configuration of the management server 2 according to the present embodiment has been specifically described hereinabove.

It should be noted that the configuration of the management server 2 illustrated in FIG. 8 is an example, and the present embodiment is not limited thereto. For example, at least part of the management server 2 may be configured in an external device, and at least some of the functions of the control unit 200 may be realized by means of an external device (for example, the information processing terminal 1, an information processing device (such as a so-called edge server) having a communication distance that is relatively close to the information processing terminal 1). Further, the components and databases of the control unit 200 illustrated in FIG. 8 may all be provided in the information processing terminal 1, and the learning support system according to the present embodiment may be executed by means of an application in the information processing terminal 1.

### 3. OPERATION PROCESSING

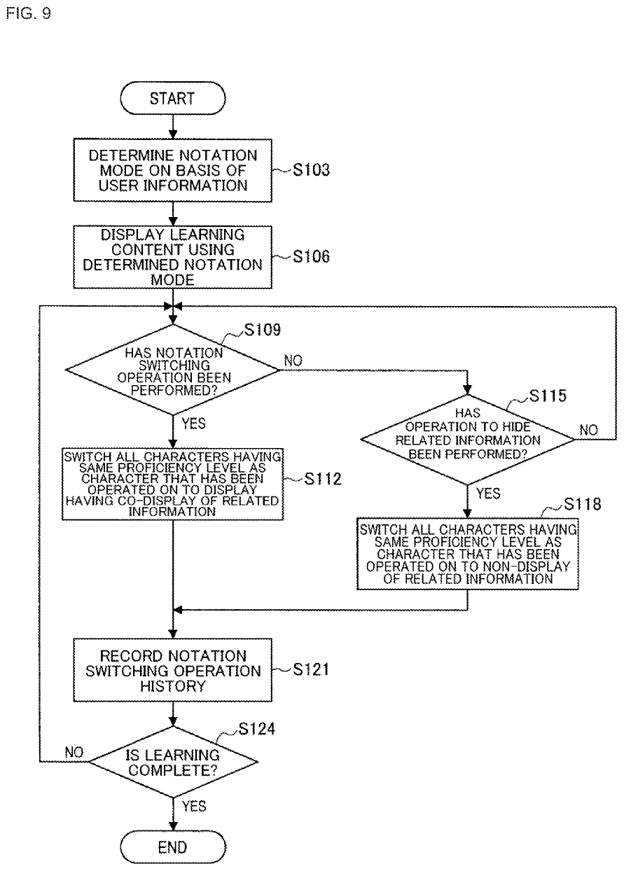

Notation switching control processing in the learning support system according to the present embodiment will next be described specifically using the drawings. FIG. 9 is a flowchart illustrating an example of the overall flow of notation switching control processing in the learning support system according to the present embodiment.

As illustrated in FIG. 9, first the notation mode determining unit 101 of the information processing terminal 1 determines the notation mode on the basis of the user information (step S103). For example, the notation mode determining unit 101 determines the notation mode corresponding to the school grade of a user on the basis of the age of the user.

Next, the control unit 100 displays the learning content using the determined notation mode (step S106). For example, the control unit 100 performs control to display kanji that are learned up to the school grade of a user using kanji notation, and to display others using hiragana or a kanji notation with co-displayed furigana (so-called ruby notation).

Next, if a notation switching operation has been performed (step S109/Yes), the notation switching unit 102 switches all the characters in the same proficiency level as the character that has been operated on to a display in which the related information is co-displayed (step S112). For example, the notation switching unit 102 refers to school-grade-specific kanji allocation information, and performs control to change the kanji selected by the user operation, and all kanji in the same proficiency level as the kanji, out of the displayed character string, to be displayed using a kanji notation with co-displayed furigana (so-called ruby notation).

Meanwhile, if an operation to hide the related information has been performed (step S115/Yes), the notation switching unit 102 switches all the characters in the same proficiency level as the character that has been operated on to a display in which the related information is hidden (step S118). For example, the notation switching unit 102 refers to the Gakunen-betsu Haito Kanji Toho (School-grade-specific allocated kanji information), and performs control to change the kanji with co-displayed furigana, selected by the user operation, and all kanji in the same proficiency level as the kanji, out of the displayed character string, to a kanji notation with the furigana hidden.

Next, the control unit 100 records the notation switching operation history, such as the operation indicated in step S109 and the operation indicated in step S115, to the database (step S121). The notation switching operation history may be transmitted to the management server 2.

An example of operation processing according to the present embodiment has been described hereinabove. It should be noted that the operation processing illustrated in FIG. 9 is an example, and the present disclosure is not limited to the example illustrated in FIG. 9. For example, the present disclosure is not limited to the order of the steps illustrated in FIG. 9. At least any of the steps may be processed in parallel, and may be processed in the reverse order. Further, not all the processing illustrated in FIG. 9 necessarily needs to be executed. Further, not all the processing illustrated in FIG. 9 necessarily needs to be performed by a single device.

For example, the processing in step S118 may be configured to switch only the characters that are the same as the character that has been operated on, out of the character string, such that the related information is hidden. Further, instead of steps S115 to S118, the notation switching unit 102 may switch to a display in which the related information is hidden when the related information co-display notation has been displayed a certain number of times.

### 4. SUMMARY

As discussed hereinabove, the learning support system according to an embodiment of the present disclosure enables more appropriate character string notation change control to be performed with respect to a user.

According to the present embodiment, the notation mode is controlled to match the learning level of a user, without the user performing an operation each time, thereby enhancing the convenience of the learning content.

Further, awkward character trends for a user or a user group, and the language proficiency level thereof, can be acquired more accurately by means of data analysis based on the notation switching operation history of the user, for example, allowing the teacher to ascertain more accurately the awkward character trends and language proficiency level of a student or class.

Further, since display/non-display of the related information can be dynamically switched, as appropriate, in accordance with a user, the burden due to related information notation registration by the learning content creator is reduced. For example, the related information used in the present embodiment may be acquired, as appropriate, by the management server 2 or the information processing terminal 1 from dictionary data or the like on the network.

A preferred embodiment of the present disclosure has been described in detail hereinabove with reference to the accompanying drawings, but the present technology is not limited to the examples. It is obvious that persons having a normal level of knowledge in the technical field of the present disclosure could conceive of various variations or modifications, within the scope of the technical concepts recited in the claims, and it is to be understood that these are of course also included within the technical scope of the present disclosure.

For example, it is also possible to create a computer program for causing hardware such as the CPU, ROM, and RAM built into the information processing terminal 1 or the management server 2 discussed hereinabove to exhibit the functions of the information processing terminal 1 or the management server 2. Also provided is a computer-readable storage medium having the computer program stored thereon.

Further, the advantages described in this specification are purely explanatory or illustrative, and are not limiting. That is, the technology pertaining to the present disclosure may exhibit other advantages that are apparent to persons skilled in the art on the basis of the descriptions in this specification, in addition to the advantages described hereinabove or instead of the advantages described hereinabove.

It should be noted that the present technology can also adopt configurations such as the following.

(1)

An information processing device including:

a control unit, the control unit being configured to perform control to display a character string using a predetermined notation mode corresponding to a school grade of a user; and

control to switch the notation mode to another such that related information is co-displayed together with a character selected by the user and a character belonging to the same proficiency level group as the selected character, out of the character string.

(2)

The information processing device as described in (1) wherein, when a character in the notation mode in which the related information is co-displayed is selected by the user, the control unit performs control to switch the notation mode in which the selected character and a character belonging to the same proficiency level group as the selected character to a notation mode in which the related information is not co-displayed.

(3)

The information processing device as described in (1), wherein the predetermined notation mode corresponding to the school grade of the user includes a character type to be used, or whether the related information is to be co-displayed.

(4)

The information processing device as described in (3), wherein the character type includes kanji, hiragana, and katakana, and the related information includes furigana.

(5)

The information processing device as claimed in (3), wherein the character type includes the alphabet, and the related information includes furigana.

(6)

The information processing device as described in (3), wherein the related information includes a phonetic symbol.

(7)

The information processing device as described in (3), wherein, on the basis of school-grade-specific kanji allocation table information, the control unit determines kanji and hiragana notation to be the predetermined notation mode corresponding to the school grade of the user.

(8)

The information processing device as described in (7), wherein the control unit co-displays furigana together with kanji selected by the user and kanji belonging to the same proficiency level group as the selected kanji, out of the character string.

(9)

The information processing device as described in (8), wherein the control unit hides the furigana when kanji with co-displayed furigana has been displayed a predetermined number of times.

(10)

The information processing device as described in any one of (1) to (4), wherein the control unit converts all kanji that are the same as the kanji selected by the user, out of the character string, to hiragana.

(11)

The information processing device as described in any one of (1) to (10), wherein the selection of the character by the user is performed by means of a touch operation with respect to the character that is being displayed.

(12)

The information processing device as described in any one of (1) to (11), wherein the selection of the character by the user is performed by means of a swipe operation with respect to the character that is being displayed.

(13)

The information processing device as described in any one of (1) to (12), wherein the proficiency level group includes one or a plurality of proficiency-level-specific groups based on character learning content specific to each school grade.

(14)

The information processing device as described in any one of (1) to (13), wherein the control unit calculates a character proficiency level of the user on the basis of the history of notation change operations performed by the user.

(15)

An information processing method including the steps executed by a processor of: performing control to display a character string using a predetermined notation mode corresponding to the school grade of a user; and performing control to switch the notation mode to another such that related information is co-displayed together with a character selected by the user and a character belonging to the same proficiency level group as the selected character, out of the character string.

(16)

A program for causing a computer to function as

a control unit configured to perform:

control to display a character string using a predetermined notation mode corresponding to a school grade of a user; and

control to switch the notation mode to another such that related information is co-displayed together with a character selected by the user and a character belonging to the same proficiency level group as the selected character, out of the character string.

### REFERENCE SIGNS LIST

1 Information processing terminal
100 Control unit
101 Notation mode determining unit
102 Notation switching unit
103 Feature extracting unit
110 Communication unit
120 Input unit
130 Output unit
140 Storage unit
2 Management server
200 Control unit
201 User information management unit
202 Analyzing unit
210 Communication unit
220 Storage unit
3 Network

1. An information processing device comprising:
a control unit, the control unit being configured to perform
control to display a character string using a predetermined notation mode corresponding to a school grade of a user; and
control to switch the notation mode to another such that related information is co-displayed together to a character selected by the user and a character belonging to the same proficiency level group as the selected character, out of the character string.

2. The information processing device as claimed in claim 1, wherein,
when a character in the notation mode in which the related information is co-displayed is selected by the user, the control unit performs control to switch the notation mode in which the selected character and a character belonging to the same proficiency level group as the selected character to a notation mode in which the related information is not co-displayed.

3. The information processing device as claimed in claim 1, wherein
the predetermined notation mode corresponding to the school grade of the user includes a character type to be used, or whether the related information is to be co-displayed.

4. The information processing device as claimed in claim 3, wherein
the character type includes kanji, hiragana, and katakana, and
the related information includes furigana.

5. The information processing device as claimed in claim 3, wherein
the character type includes the alphabet, and
the related information includes furigana.

6. The information processing device as claimed in claim 3, wherein the related information includes a phonetic symbol.

7. The information processing device as claimed in claim 3, wherein,
on the basis of school-grade-specific kanji allocation table information, the control unit determines kanji and hiragana notation to be the predetermined notation mode corresponding to the school grade of the user.

8. The information processing device as claimed in claim 7, wherein
the control unit
co-displays furigana together with kanji selected by the user and kanji belonging to the same proficiency level group as the selected kanji, out of the character string.

9. The information processing device as claimed in claim 8, wherein
the control unit
hides the furigana when kanji with co-displayed furigana has been displayed a predetermined number of times.

10. The information processing device as claimed in claim 1, wherein
the control unit
converts all kanji that are the same as the kanji selected by the user, out of the character string, to hiragana.

11. The information processing device as claimed in claim 1, wherein the selection of the character by the user is performed by means of a touch operation with respect to the character that is being displayed.

12. The information processing device as claimed in claim 1, wherein the selection of the character by the user is performed by means of a swipe operation with respect to the character that is being displayed.

13. The information processing device as claimed in claim 1, wherein the proficiency level group includes one or a plurality of proficiency-level-specific groups based on character learning content specific to each school grade.

14. The information processing device as claimed in claim 1, wherein
the control unit
calculates a character proficiency level of the user on the basis of the history of notation change operations performed by the user.

15. An information processing method comprising the steps executed by a processor of:
performing control to display a character string using a predetermined notation mode corresponding to a school grade of a user; and
performing control to switch the notation mode to another such that related information is co-displayed together with a character selected by the user and a character belonging to the same proficiency level group as the selected character, out of the character string.

16. A program for causing a computer to function as
a control unit configured to perform:
control to display a character string using a predetermined notation mode corresponding to a school grade of a user; and
control to switch the notation mode to another such that related information is co-displayed together with a character selected by the user and a character belonging to the same proficiency level group as the selected character, out of the character string.
